(19) United States
(12) Patent Application Publication
(10) Pub. No.: US 2002/0116167 A1
(43) Pub. Date: Aug. 22, 2002

(54) Method for simulating mobility in an urban area

(75) Inventors: Graziano Servizi, Bologna (IT); Armando Bazzani, Bologna (IT); Bruno Giorgini, Bologna (IT); Giorgio Turchetti, Bologna (IT)

Correspondence Address: Ladas & Parry, 26 West 61 Street, New York, NY, 10023, US

(73) Assignee: UNIVERSITA' DEGLI STUDI DI BOLOGNA

(21) Appl. No.: 10/032,810

(22) Filed: Dec. 26, 2001

(30) Foreign Application Priority Data
Dec. 29, 2000 (EP) 00830868.6

(51) Int. Cl. G06F 9/45

(52) U.S. Cl. 703/22

(57) ABSTRACT

Method for simulating mobility in an urban area comprising the phases of defining the urban area by means of a plurality of nodes and a plurality of destination areas; assigning to a plurality of individuals a respective position and a condition of mobility; assigning to each individual belonging to a first part individuals a first random direction of movement; establishing for each individual belonging to the first part of individuals a second direction of movement, which is determined according to both the distance of its own position from the destination areas associated with it and the first direction of movement; updating the position of each individual belonging to the first part of individuals according to both its own condition of mobility and said second direction.

The present invention relates to method for simulating mobility in an urban area.

### BACKGROUND OF THE INVENTION

As is known, the methods for simulating urban mobility are suited for supplying a forecast of the evolution in time of the movement of vehicles and individuals within a determined urban area.

The currently known methods for simulating urban mobility assign to each individual and/or vehicle a precise, unique and deterministic destination, that is they determine the movements of individuals and vehicles, using deterministic formula of the origin-destination type.

In particular, in the above-mentioned methods for simulating urban mobility, a specific route and a determined speed of movement are assigned to each individual and to each means of transport, that is the movement of the individual and of the means of transport in the urban area are established a priori.

The above-mentioned methods for simulating urban mobility present the problem that they exclude any situation of an uncertain nature that originates as the individual moves in the urban area.

### SUMMARY OF THE INVENTION

The aim of the present invention is therefore to provide a method for simulating mobility in an urban area without the problems described above.

According to the present invention a method for simulating mobility in an urban area is supplied as described in claim 1.

### BRIEF DESCRIPTION OF THE DRAWINGS

The present invention will now be described with reference to the annexed drawings, which illustrate a non limiting embodiment, in which:

FIG. 1 illustrates a block diagram relating to a method for simulating mobility in an urban area operating according to the dictates of the present invention;

FIG. 2 illustrates a block diagram relating to some operations carried out in the method for simulating mobility in an urban area operating according to the dictates of the present invention;

FIG. 3 illustrates a block diagram relating to some operations carried out in the method for simulating mobility in an urban area operating according to the dictates of the present invention;

FIG. 4 illustrates a block diagram relating to some operations carried out in the method for simulating mobility in an urban area operating according to the dictates of the present invention; and

FIG. 5 illustrates a block diagram relating to some operations carried out in the method for simulating mobility in an urban area operating according to the dictates of the present invention.

### DETAILED DESCRIPTION OF THE INVENTION

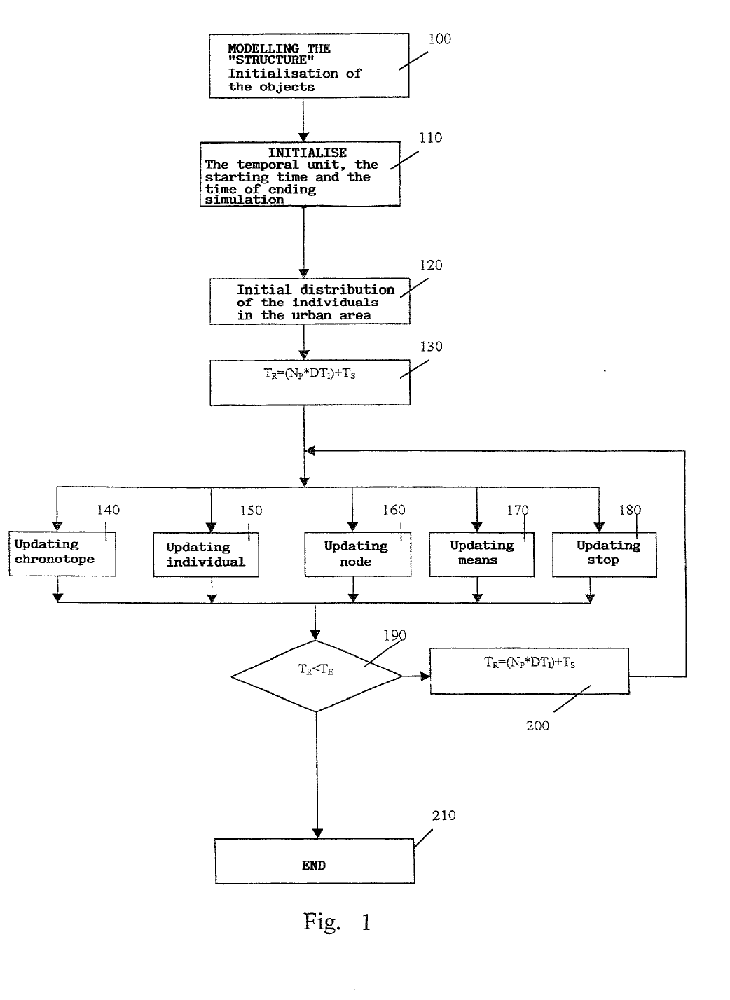

With reference to FIG. 1, a flow diagram is shown relating to a method for simulating mobility in an urban area suited for making a forecast of the mobility of several individuals within a determined urban area.

In particular, the simulation method is suited for forecasting the evolution of a “system” comprising a plurality of “objects” which interact with each other according to a discrete stochastic formula, which considers the mobility of each individual object, the variations of movement (flow variations) of a plurality of individual objects within the determined urban area, the restraints imposed by the bio-rhythms of the individual objects and by the chronotopical and morphological structure of the urban area.

More particularly, in the simulation model one or more destination areas present within the urban area are assigned to a predetermined number of individual objects.

In other words, some individuals are assigned “tendencies” of movement towards one or more destination areas indicated below with the term “chronotopes”, that is towards a plurality of geographically limited areas, each one of which is within the urban area and is characterised by its own specific temporal dynamic.

In the method for simulating urban mobility, the “objects” included in the “system” are suited for defining the individuals, the chronotopes, the nodes, the paths and the means of transport present within the urban area.

The chronotope objects in turn comprise place objects, while the node objects comprise the stop objects. Each individual object is defined by the following parameters.

An individual code suited for unmistakably indicating each individual object, thus distinguishing it from the other individual objects, and comprising information such as, for example, sex, age, social condition, etc.

A finite number of “charge” parameters each indicating the tendency of the individual object to move towards one or more chronotope objects. For example, a student type individual object could include a “charge” indicating the student's tendency to move or not to move towards a university type chronotope object.

In particular, each of the “charge” parameters contains an indication of the presence or absence of the tendency (of the on/off type, equivalent to present/absent) of an individual object to move towards a determined chronotope object.

Each individual object also comprises a vector suited to memorise a predetermined number NUM of movements performed by the individual object, and a status indicator suited for containing three statuses, each of which indicates a specific condition of mobility of the individual object.

In particular, the individual object may present a first status indicating a condition of mobility in which he moves as a pedestrian, a second status indicating a condition of mobility in which the individual object moves as a user, that is when he is moving on a means of transport object, and a third status indicating a condition of mobility in which the individual object is in a status of waiting, that is he is at a stop object, waiting for a means of transport object.

Each individual object also comprises a parameter containing a value indicating the probability of movement of the same individual object towards a determined direction.

Each individual object also comprises a “slowness” parameter indicating the slowing down of the individual object when moving on foot (pedestrian status) through a plurality of individual objects, and a minimum distance and threshold D_{MIN}, F_{MIN} indicating together a reference value suited to allow one to decide whether the individual object must move within the area in a random or non random manner.

The chronotope objects are defined by a limited area (present in the urban area) which s distinguished from the rest of the same urban area by means of its spatial character and its temporal rhythms of activity.

Each chronotope object is defined by the following parameters.

A name suited for identifying each chronotope object in the urban area; for example a hospital, a university, a cinema, a theatre, a sports centre, etc.

A geometric centre, a diameter, a number indicating the ends, a parameter indicating the number of node objects contained in the chronotope object, a parameter indicating which and how many place objects are contained in the chronotope object, a parameter indicating the number of individual objects tending to the chronotope object.

The chronotope object is further defined by the following parameters.

A parameter indicating the number I of individual objects present within the chronotope object in each instant of time, a parameter indicating a “field of attraction” that is an attraction force F_{ATT} defined by a quantized elastic force which is cancelled within the chronotope object in such a way that each individual object, which arrives at the chronotope object, begins a random movement.

In particular the attraction force F_{ATT} may be defined by the equation F_{ATT}=−KX where K is a constant and X is the distance of the individual object measured with respect to the geometric centre of the chronotope object.

The chronotope object also comprises a number of steps of quantization of the “field of attraction” and a number of temporal steps which indicate the temporal dynamic of the chronotope, that is they define when the chronotope is “active” or “inactive”.

Each chronotope object is in fact characterised by precise temporal rhythms during which the chronotope object itself is “active” and therefore “attracts” the individual objects which tend towards it, or “inactive” and therefore “does not attract” any individual object, irrespective of the tendency of the later. These temporal rhythms will be indicated below with the term “calendarisation”.

For example, a university chronotope object may be “active” (accessible to individual objects) in a determined daily time interval (from 7.00 to 20.00), while a theatre chronotope object may be “active” (accessible to individual objects) in an evening time interval (from 21.00 to 24.00) and “inactive” the rest of the time.

In this case, the theatre chronotope object presents a different “calendarisation” from the university chronotope object, that is a different temporal dynamic. Each node object presents at least one direction of elementary movement towards at least one adjacent node and is defined by the following parameters.

A parameter indicating the adjacent node objects, a parameter indicating the path objects that lead to the node object or, parameter indicating the exits which lead from the node object to the outside of the urban area concerned, a parameter indicating the chronotope object belonging to the node object, a parameter indicating the number I of individual objects present in the node object, a parameter indicating the friction A(I) of the node object and a parameter indicating a maximum friction A_{M}.

In particular, the friction A(I) of the node object is determined according to the number I of individual objects present in the node object itself.

Each node object further comprises the following parameters.

A finite number of local intensity values I_{L} indicating the attraction force F_{ATT} exerted by each chronotope object on the node object, a finite number of values indicating the distances X_{I} from each chronotope object present in the urban area considered and a vector which identifies the geometric position of the node object in the urban area.

Each node object finally comprises a parameter indicating whether the same node object presents the stop function, that is if it coincides with the stop object.

Each path object is suited for connecting each node to a respective adjacent node and is defined by the following parameters.

A parameter indicating the coordinates which define the initial and final point of the path object, a parameter indicating the number of exits of the path object form the urban area concerned, a path indicting how many and which node objects are present in the path object, a parameter indicating (by means of a Boolean variable) whether the path object is or is not followed by a means of transport object.

Each means of transport object is defined by the following parameters.

A parameter indicating the position of the means of transport object, a parameter indicting the transport line to which the means of transport object belongs, a parameter indicating the number UI and the codes of the individual objects that occupy the means of transport object, a parameter indicating the maximum capacity T_{MAX} of the means of transport object, a parameter indicating the route of the means of transport object, or the coordinates of the stop objects that may be reached in sequence by the means of transport object and a vector indicating the stop objects.

In particular, the parameter indicating the stop objects comprises a plurality of values, each indicating a whole index which unmistakably identifies the stop object.

Each means of transport object further comprises a number indicating how many stop objects the means of transport object encounters, a parameter indicating if the route is closes, that is if it is circular, or if it goes and comes back, a parameter indicating the speed of the means of transport object, a parameter indicating the “slowness”, that is, similar to the individual object, the slowing down of the means of transport object.

Each place object is defined by a determined circumscribed area comprised within a chronotope object.

For example the university chronotope object comprises a plurality of place objects, or departments (faculty of engineering, faculty of chemistry) presenting a temporal dynamic regulated by the chronotope object to which they belong.

The place object is defined by the following parameters.

A parameter indicating the chronotope object to which it belongs, a parameter indicating the maximum capacity I_{MAX} of the place object, the accessibility of the place object (a Boolean variable), a field which assumes a value zero outside the chronotope object with which the place object is associated, and a constant value within the chronotope object.

The place object is further defined by all the parameters that define the chronotope object.

The stop objects are defined by the following parameters.

A code unmistakably indicating the stop object, a parameter indicating the node object in which the stop object is situated, a parameter indicating the number and the codes identifying the means of transport objects present in a determined moment of time t at the stop object, a parameter indicating the maximum number of means of transport that may be contained by the stop object, a parameter indicating the number and the codes identifying the means of transport objects expected.

The stop object is further defined by all the parameters that define the node object.

With reference to FIG. 1, the method for simulating urban mobility arrives initially at block 100, in which the parameters of the objects described above are initialised.

In detail, the urban area “system” is defined in block 100, that is the urban area itself is “modelled” by means of a plurality of the objects described above.

In greater detail, in block 100 are initialised both the objects (path, chronotope, node, means of transport, stop) which form the structure of the urban area, and the individual objects involved in said urban area with their movements.

In particular, a correspondence (1-1) with the urban roads present in the area is associated with the path objects so as to provide a static spatial representation of the urban area itself.

Vice-versa, the node, chronotope and means of transport objects provide a temporal and dynamic representation of the urban area.

In detail, to each path object are assigned a predetermined number of node objects, the distance of which (one from the other) is defined by a number N_{P} of temporal steps taken by an individual object or by a means of transport object to reach a determined node, starting from an adjacent node.

Each temporal step is defined by a predetermined temporal unit DT_{I}; for example, two adjacent node objects can present such a distance that they may be reached by an individual object in a number of temporal steps N_{P}=8, that is in a time interval of T=N_{P}* DT_{I}=8*DT_{I}, and by a means of transport object in a number of temporal steps N_{P}=4, that is in a time interval of T=4*DT_{I}.

It is opportune to point out that the “slowness” parameter (present in both individual objects and in means of transport objects) provides a value indicating a number of steps N_{P}to be added in the presence of friction A(I) to the normal number of steps necessary to cover the distance between two nodes.

In other words, the “slowness” is a parameter which indicates the number of temporal steps N_{P} during which the individual or means of transport object remains stopped waiting for the friction A(I) to decrease.

The block 100 is followed by the block 110, in which the temporal unit DT_{I}, is initialised. In this way, the distances between the node objects are defined in terms of temporal steps N_{P}.

In block 110 are also initialised an initial time T_{S} and a final time T_{E} which define a temporal window (T_{E}−T_{S}) within which urban mobility is simulated.

In block 110 are initialised, moreover, the number of temporal steps N_{P}=0, and an event time which initially assumes the value T_{R}(N_{P},DT_{I})=Tₛ.

The event time T_{R} is updated by the number of temporal steps N_{P} according to the equation T_{R}=(N_{P}*DT_{I})+T_{S} and is suited for indicating the instant in time T in which the simulation of mobility occurs.

The block 110 is followed by the block 120, in which the individual objects are distributed, by means of a known statistical function, on the urban area, that is on the node objects, on the chronotope objects, on the place objects and on the means of transport objects.

In particular, in block 120 the individual objects are distributed in the objects described above, considering both the tendency of each individual object to move towards a chronotope object and the status of activity/inactivity of the latter in the instant in time T=T_{S}.

In block 120, each individual is therefore assigned a position and a condition of mobility indicating the status of movement of the individual object.

In particular, the condition of mobility can indicate a pedestrian status, in which the individual object is in a condition of movement on foot, a user status in which the individual object is in a condition of movement with a means of transport object, and a status of waiting in which the individual object is present at a stop object to wait for the arrival of a means of transport object.

The block 120 is followed by the block 130, in which the number of temporal steps N_{P}=N_{P}+1 is increased, and therefore also the event time T_{R}=T_{S}+(DT_{I}*N_{P}).

The block 130 is followed by the blocks 140, 150, 160 170, 180 (which will be described in detail below), in which the chronotope, individual, node, means of transport and stop objects are updated.

Each of the blocks 140, 150, 160 170, 180 is followed by the block 190, in which the relation T_{R}<T_{E} is checked.

In the positive case, that is if T_{R}<T_{E}, the block 190 is followed by the block 200, in which the number of temporal steps N_{P}=N_{P}+1 is increased, and therefore also the event time T_{R}=(N_{P}* DT_{I})+T_{S}, while if T_{R}=T_{E}, the block 190 is followed by the block 210, in which the simulation method is ended.

The block 200 is followed by the blocks 140, 150, 160 170, 180 within which takes place a new updating cycle of the objects in the new instant in time T=T_{R}.

In detail, in block 140 each chronotope object present in the urban area is updated at each temporal step N_{P} (and therefore the instant in time T=T_{R}).

In greater detail, in block 140, in the instant in time T=T_{R}, the parameter containing the number I of individual objects present in the chronotope object is updated.

In block 140 are also updated the place objects that form a part of each chronotope object.

In detail, for each place object the parameter indicating the accessibility of the place object itself is updated. In particular, this accessibility is determined according to the maximum capacity I_{MAX} of the place object and to the number I of individual object present in the place object.

In greater detail, if I<I_{MAX} the place object is accessible, otherwise it is inaccessible.

Finally, in block 140 the activity/inactivity status (calendarisation) of the chronotope object is updated according to the event time T_{R}, that is it is estimated whether the chronotope object is active or inactive at the instant in time T=T_{R}.

In block 160 each node object is updated at each temporal step N_{P} and therefore at each increase of the event time T_{R}.

In particular, in block 160 are updated both the parameter containing the number of individual objects I present in the node object at the instant in time T=T_{R}, and the parameter indicating the friction A(I) present between the individual objects moving in the node object itself.

In detail, the updating of the friction A(I) in the node object is carried out according to the following equation A(I)=I/R of a known type, in which R is a predetermined known constant.

In greater detail, if the friction A(I) present in the node object is lower than a predetermined friction threshold ARIF (A(I) <ARIF), the node object is considered free from friction and so the movement of the individual object is not liable to slowing down.

In this case the distance between two adjacent node objects is covered by the individual object in the initially predetermined number of temporal steps N_{P} (block 100).

If the friction A(I) present in the node object is higher than or equal to the friction threshold ARIF, the movement of the individual object present in the node object in a determined instant in time T=T_{R} is delayed according to the “slowness” parameter which supplies an increase value to the number of steps N_{P} necessary to cover the distance between two nodes.

In block 170 all the means of transport objects are updated at each temporal step N_{P} and therefore at each increase of the event time T_{R}.

In particular, in block 170 are updated both the parameter containing the number of individual objects I present in the means of transport object at the instant in time T=T_{R}, and the parameter indicating the stop object or node in which the means of transport object is present at the instant in time T=T_{R}.

In block 180 all the stop objects are updated at each temporal step N_{P} and therefore at each increase of the event time T_{R}.

In particular, in block 180 are updated both the parameter containing the number of individual objects I present in the stop transport object at the instant in time T=T_{R}, and the parameter indicating the number and the codes that identify the means of transport arriving at the temporal step N_{P}+1.

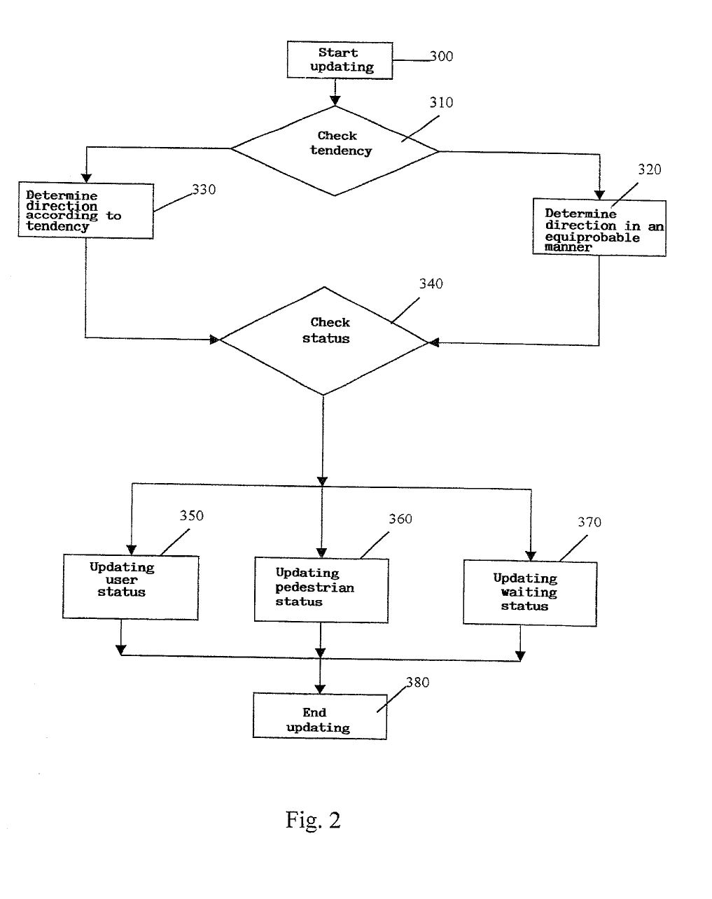

With reference to FIG. 2, a flow diagram is illustrated with relation to the updating of the individual objects (carried out in block 150 of FIG. 1).

In detail, the updating of the individual objects begins in block 300.

The block 300 is followed by the block 310, in which it is checked whether the individual object has destination areas, or whether or not it tends towards a chronotope object.

In greater detail, the parameter containing the “charge” is controlled, indicating the tendency or otherwise (on/off) of the individual object to move towards a determined chronotope object.

If the individual object has no destination area and therefore has no tendency (off) towards any chronotope object, the block 310 is followed by the block 320, in which the individual object itself is assigned a probability of uniform movement in the N directions of elementary movement (towards N adjacent nodes), that is it is assigned in an equiprobable (random) manner one o the elementary directions of movement which connect the node object (in which the individual object is situated) with the adjacent node object.

Instead, if the individual object tends (on) towards one or more chronotope objects, and depending on their status of activity/inactivity (calendarisation) is tending to one of theses, the block 310 is followed by the block 330, in which a preferential probability for the directions that favour the approach of the individual object to the destination chronotope object is overlapped on the equiprobability of movement in the N directions.

In this way the equiprobability of movement in the N directions is influenced by the value of the attraction force F_{ATT}=−KX of the chronotope object on the individual object present in the node object.

In other words, the probabilistic component related to the directions that favour the approach of the individual object to the chronotope object to which it tends is increased.

The new direction of movement of the individual object is determined according both to the distance o the position of the individual object with respect to the destination chronotope object associated with it and to the equiprobability of movement in the N elementary directions.

In block 320 and 330 a probable movement is therefore established for the updating of the position of the individual object.

The blocks 320 and 330 are followed by the block 340 in which the condition of mobility, that is the status of the individual object, is checked.

The block 340 is followed by the blocks 350, 360, 370 in which the status of the individual object at the instant in time T=T_{R} is updated.

In particular, when user status is ascertained, the block 340 is followed by the block 350 in which the user status is updated.

If pedestrian status is ascertained, the block 340 is followed by the block 360 in which the pedestrian status is updated.

Finally, if waiting status is ascertained in block 340, the block 340 is followed by the block 370 in which the waiting status is updated.

The blocks 350, 360, 370 are followed by the block 380, in which the updating of the individual object is ended.

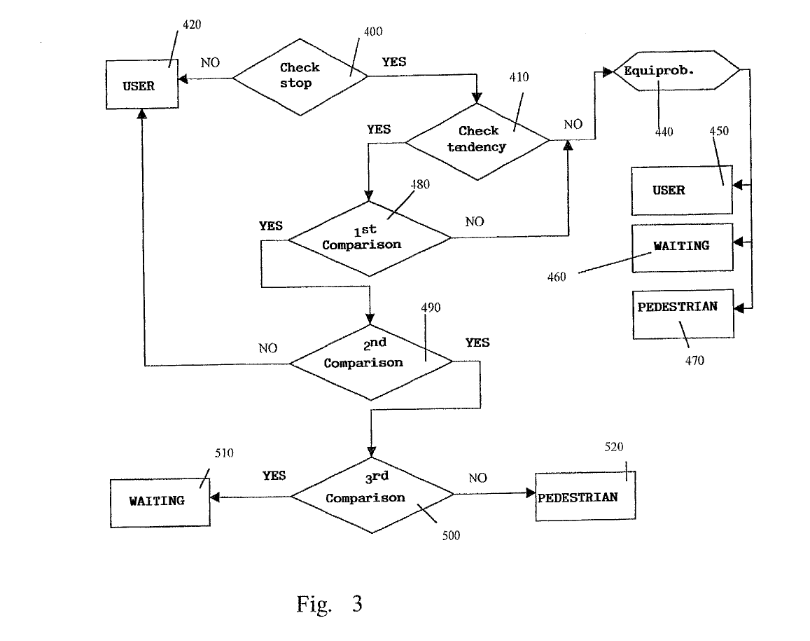

With reference to FIG. 3, a flow diagram is illustrated with relation to the updating of the user status (represented in block 350 present in FIG. 2) of an individual object.

The updating of an individual object presenting user status begins with the block 400, in which it is checked whether the means of transport object containing the individual object is present in a stop object.

In the positive case, that is in the case of presence of the means of transport object in a stop object, the block 400 is followed by the block 410, in which an assessment is made of the “tendency” of the individual object to move towards a chronotope object, while, in the negative case, the block 400 is followed by the block 420, in which the individual object is maintained in user status.

If the individual object has no tendency towards a chronotope object, the block 410 is followed by the block 440, in which a transition is made, in a random manner, that is in an equiprobable manner, from user status to one of the three statuses.

If user status is assigned in the block 440, the block 440 is followed by the block 450, in which the direction of movement of the means of transport object is assigned to the individual object.

If waiting status is assigned, the block 440 is followed by the block 460 in which the individual object remains in the stop object waiting for the arrival of a means of transport object.

If pedestrian status is assigned in the block 440, the block 440 is followed by the block 470, in which the individual object is shifted according to the direction of elementary movement determined in a random manner in the block 310 illustrated in FIG. 2.

If the individual object has a tendency towards a chronotope object, the block 410 is followed by the block 480, in which the local intensity of the attraction force F_{ATT} of the chronotope object on the stop object is compared with the predetermined minimum threshold F_{MIN}.

From the above description it should be pointed out that the attraction force F_{ATT} is determined (F_{ATT}=−K*D1) according to the distance D1 of the stop object from the destination chronotope object.

If the attraction force F_{ATT} is below the predetermined minimum threshold F_{ATT}<F_{MIN}, the block 480 is followed by the block 440, in which, as described above, the new status of the individual object is assigned in an equiprobable manner.

If the attraction force is higher than the predetermined minimum threshold F_{ATT}>F_{MIN}, the block 480 is followed by the block 490, in which is recorded, as well as the first distance D1 of the stop object (in which is situated the means of transport object) from the destination chronotope object, a second distance D2 between the latter and the stop object (involved by the means of transport at the next instant in time).

In the block 490 the ratio between the first and the second distance D1/D2 is calculated.

If the result of this ratio is below a predetermined threshold S2 (D1/D2<S2), the block 490 is followed by the block 420, in which the individual object is again assigned user status.

If the result of this ratio is above the predetermined threshold S2 (D1/D2>S2), the block 490 is followed by the block 500, in which is calculated a first temporal interval T1, which is given by the product of the time unit DT₁, and the number of temporal steps N_{P1}necessary to reach the chronotope object on foot, starting from the node object (T1=DT_{I}* N_{P1}).

In other words, the first temporal interval T1 is equal to the time necessary for the individual object to reach on foot the chronotope object to which it tends.

In the block 500 a second temporal interval T2 is also calculated, which is given by the product of the time unit DT_{I} and the number of temporal steps N_{P1}necessary for the means of transport (which is moving in the direction of the chronotope object to which the individual object tends) to reach the stop object (T2=DT_{I}* N_{P2})

In other words, the second temporal interval T2 is equal to the time taken by the individual object to wait for the arrival at the stop object of a means of transport object which is moving in direction of the chronotope object to which the same individual object tends).

From the above description it should be pointed out that the first and the second temporal interval T1, T2 also depend on the “slowness” parameter present both in the individual object (movement on foot) and in the means of transport object.

Finally, in block 500 the value of the ratio T1/T2 between the first and the second temporal interval T1, T2 is compared with a predetermined threshold S3.

If this ratio is higher than the predetermined threshold (T1/T2)>S3, the block 500 is followed by the block 510, in which a transition is made from user status to waiting status, while in the opposite case the block 500 is followed by the block 520, in which a transition is made from user status to pedestrian status and the direction of movement established in block 320 of FIG. 2 is assigned to the individual object.

From the above description it should be pointed out that in waiting status the individual object waits for a means of transport object presenting a direction of movement that does not necessarily correspond to the direction of the chronotope object of the tendency, but such as to reach a stop object resenting a distance D1 from the chronotope object that is shorter than the distance presented by any one of the stop objects included in the route followed by the means of transport object on which the individual object previously presented user status.

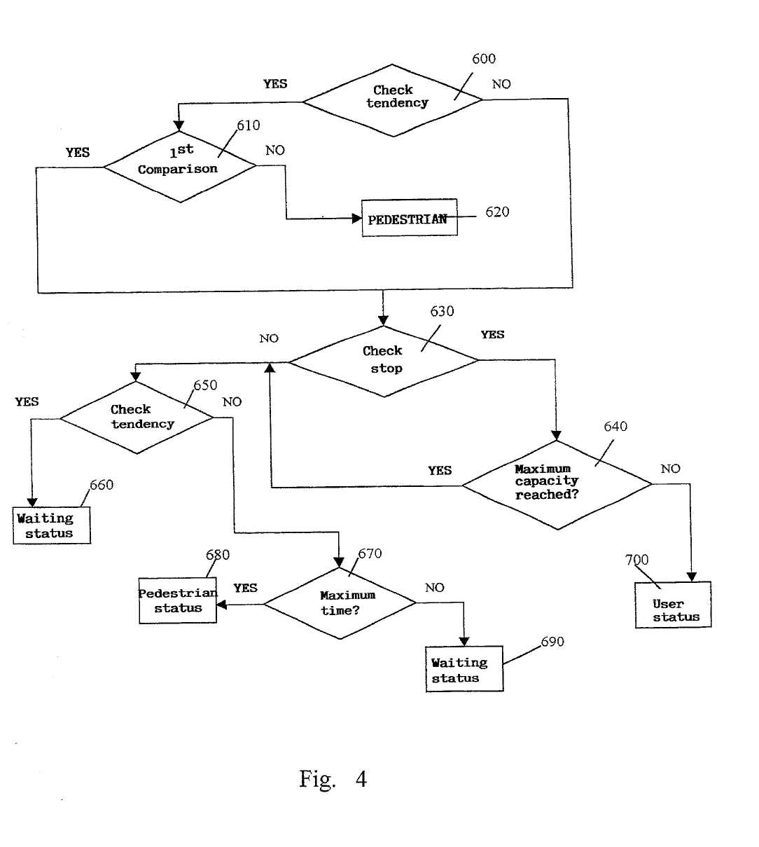

With reference to FIG. 4, a flow diagram is illustrated with relation to the updating of the waiting status (represented in block 370 present in FIG. 2) of an individual object.

In this updating the individual object is of course present in a stop object.

The updating of the waiting status of an individual object begins with the block 600, in which it is checked whether the individual object ends or does not tend towards a chronotope object.

In the negative case, that is if the individual object has no tendency towards a chronotope object, the block 600 is followed by the block 630.

In the positive case, that is if the individual object has a tendency towards a chronotope object, the block 600 is followed by the block 610, in which is calculated a first temporal interval T1, which is given by the product of the time unit DT_{I} and the number of temporal steps N_{P1} necessary to reach the chronotope object on foot, starting from the node object (T1=DT_{I}* N_{P1})

In other words, the first temporal interval T1 is equal to the time necessary for the individual object to reach on foot the chronotope object, starting from the stop object.

In the block 610 a second temporal interval T2 is also calculated, which is given by the product of the time unit DT_{I} and the number of temporal steps N_{P2} necessary for the means of transport (which is moving in the direction of the chronotope object to which the individual object tends) to reach the stop object (T2=DT_{I}* N_{P2}).

In other words, the second temporal interval T2 is equal to the time taken by the individual object to wait for the arrival at the stop object of a means of transport object which is moving in direction of the chronotope object to which the same individual object tends).

Finally, in block 610 the value of the ratio T1/T2 between the first and the second temporal interval T1, T2 is compared with a predetermined threshold S3.

If this ratio is lower than the predetermined threshold (T1/T2)<S3, the block 610 is followed by the block 620, in which a transition of the individual object is made from waiting status to pedestrian status and the individual object is shifted according to the direction predetermined in block 320 (illustrated in FIG. 2), while in the opposite case, that is if the ratio is higher than the predetermined threshold (T1/T2)>S3, the block 610 is followed by the block 630.

In the block 630 it is checked whether the means of transport object is present in the stop object.

In the negative case, that is if the means of transport object has not arrived in the stop object, the block 630 is followed by the block 650, in which it is checked whether the individual object presents a tendency for a chronotope object.

If the individual object has a tendency for a chronotope object, the block 650 is followed by the block 660, in which the individual object maintains waiting status.

If the individual object does not present any tendency, the block 650 is followed by the block 670, in which it is checked whether the waiting time T_{A} which indicates the time that the individual object remains in the stop object exceeds a maximum tolerable time T_{TOL} .

If T_{A}>T_{TOL} the block 670 is followed by the block 680, in which the transition is made from waiting status to pedestrian status, while if T_{A}<T_{TOL} the block 670 is followed by the block 690, in which waiting status is maintained.

If the means of transport object is present in the stop object, the block 630 is followed by the block 640, in which it is checked whether the number I of individual objects present in the means of transport object is equal to the maximum capacity T_{MAX} of the means of transport object (checking capacity).

If I=T_{MAX} the block 640 is followed by the block 650 described above, while if I<T_{MAX}, the block 640 is followed by the block 700, in which the transition is made from waiting status to user status.

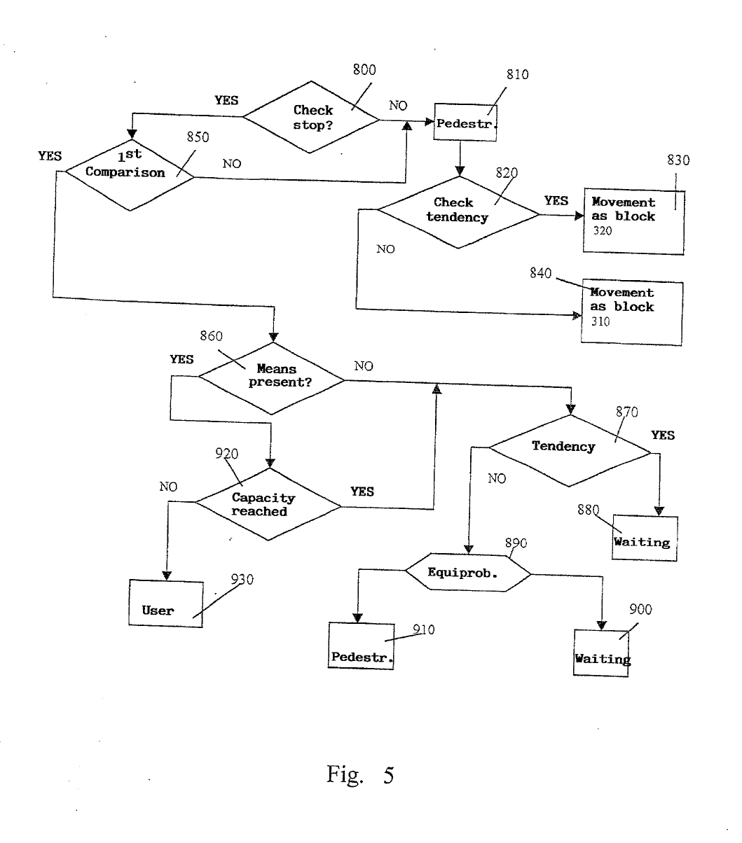

With reference to FIG. 5, a flow diagram is illustrated with relation to the updating of the pedestrian status (represented in block 360 illustrated in FIG. 2) of an individual object.

The updating of the pedestrian status of an individual object begins with the block 800, in which it is checked whether the pedestrian object is in a stop object.

In the negative case, that is if the pedestrian object is not present in a stop object (and is therefore present in a node object), the block 800 is followed by the block 810, in which the individual object maintains pedestrian status.

The block 810 is followed by the block 820, in which the tendency of the individual object is checked.

If the individual object has a tendency towards a chronotope object, the block 820 is followed by the block 830, in which the individual object is shifted according to the direction established in block 320 (illustrated in FIG. 2), while in the opposite case the block 820 is followed by the block 840, in which the individual object is shifted according to the causal direction established in block 310 (illustrated in FIG. 2).

If the pedestrian object is in a stop object, the block 800 is followed by the block 850, in which is calculated a first temporal interval T1, which is given by the product of the time unit DTᵢ and the number of temporal steps N_{P1} necessary to reach the chronotope object on foot, starting from the node object (T1=DT_{I}* N_{P1}).

In the block 850 a second temporal interval T2 is also calculated, which is given by the product of the time unit DT_{I}, and the number of temporal steps N_{P2} necessary for the means of transport (which is moving in the direction of the chronotope object to which the individual object tends) to reach the stop object (T2=DT_{I}* N_{P2})

Finally, in block 850 the value of the ratio T1/T2 between the first and the second temporal interval T1, T2 is compared with a predetermined threshold S3. If this ratio is higher than the predetermined threshold (T1/T2)>S3, the block 850 is followed by the block 860, in which it is checked whether the means of transport object is present in the stop object, while in the opposite case the block 850 is followed by the block 810 described above.

If the means of transport object has not arrived in the stop object, the block 860 is followed by the block 870, in which it is checked whether the individual object has a tendency for a chronotope object.

If the individual object has a tendency, the block 870 is followed by the block 880, in which the transition of the individual object is made from pedestrian status to waiting status.

If the individual object does not have any tendency, the block 870 is followed by the block 890, in which a transition is made, in an equiprobable manner, from pedestrian status to waiting or respectively pedestrian status.

If waiting status is assigned, the block 890 is followed by the block 900, in which the transition of the individual object is made from pedestrian status to waiting status.

If pedestrian status is assigned in block 890, the block 890 is followed by the block 910, in which the individual object is shifted according to the causal direction established in block 310 (illustrated in FIG. 2).

If the means of transport object is present in the stop object, the block 860 is followed by the block 920, in which it is checked whether the number I of individual objects present in the means of transport object is equal to the maximum capacity T_{MAX} of the means of transport object.

If I=T_{MAX} (maximum capacity reached) the block 920 is followed by the block 870 described above, while if I<T_{MAX}, the block 920 is followed by the block 930, in which the transition is made from pedestrian status to user status.

Preferably, but not necessarily, the method for simulating urban mobility carries out in block 310 (in which the movement of an individual object without tendency is established) the control of the last N node objects previously “visited” and memorised.

The method for simulating urban mobility determines the new movement in an equiprobable manner, considering that the last N node objects previously “visited” cannot be visited before N temporal steps N_{P} have elapsed.

From the above description it should be pointed out that, in the method for simulating urban mobility, if an individual object presents a “slowness” (calculated according to the friction A(I) present in the node object in which the individual object is situated) higher than a predetermined threshold, for example equal to one, the movement of the individual object is accomplished only after a number of temporal steps N_{P} equal to the “slowness” have elapsed, unless in the meantime the friction A(I) present in the node object has fallen below the predetermined threshold (de-crowding of the node object).

Finally it should be pointed out that, if an individual object with a tendency arrives in a chronotope object of tendency, and this chronotope comprises one or more place objects, the short range field parameter of these latter means that an individual object remains still in the place object and therefore in the chronotope object for a period of time equal to the activity time of the chronotope object.

The method for simulating urban mobility presents the advantage of simulating the evolution of urban mobility more realistically than the methods currently known, as it considers both the intentions of the individuals to go towards determined places, and the uncertain nature of the movement made through the urban area by each individual.

The method for simulating urban mobility in fact allows the study of the critical nature of one or more control parameters, considering the urban area as a complex “system” which organises itself and is able to manage the “tendencies” and the individual requests of mobility.

The method for simulating urban mobility may also be implemented to advantage by means of an electronic calculator, which allows the graphic display of the objects described above and their temporal evolution, thus allowing a direct control of the dynamic of the “system”.

In particular, this implementation advantageously allows the consequences of a determined urban planning to be forecast, that is it allows the interactions between the objects included in the “system” to be checked and any parameter characterising the urban area itself to be altered beforehand so as to cancel or reduce any possible critical status of urban mobility.

1.- Method (1) for simulating mobility in an urban area characterised in that it comprises the following phases:
defining (100) said urban area by means of a plurality of nodes each presenting at least one direction of elementary movement towards at least one adjacent node and a plurality of destination areas each defined by a portion of said urban area;
assigning (120) to a plurality of individuals a respective position and a respective condition of mobility;
assigning (100) to each individual belonging to a first part said individuals one or more destination areas;
assigning (320) to each individual a first direction of movement corresponding to a random elementary direction of movement;
establishing (330) for each individual belonging to the first part of said individuals a second direction of movement, which is determined according to both the distance of its own position from the various destination areas associated with it and the first direction of movement;
updating (150) the position of each individual belonging to the first part of individuals according to both its own condition of mobility and said second direction.

2.- Method according to claim 1 characterised in that it comprises the phase of updating (350) (360) (370), for each individual belonging to the first part of individuals, the condition of movement according to both the distance of its own position from the various destination areas associated with it and its own condition of mobility.

3.- Method according to claim 1 characterised in that it comprises the phase of updating (320) the position of each individual belonging to a second part of individuals according to both its own condition of mobility and said first direction.

4.- Method according to claim 3 characterised in that it comprises the phase of updating (350) (360) (370), in a random manner, the condition of mobility of each individual belonging to the second part of individuals.

5.- Method according to claim 4 characterised in that it comprises the phase of determining (350) (360) (370), for each individual belonging to the second part of individuals, a new condition of mobility according to the previous condition of mobility.

6.- Method according to claim 1 characterised in that it comprises the phases of:
assigning (100) to each of said destination areas at least one temporal window of inaccessibility having a predetermined duration;
updating (150) on said temporal window the position of each individual belonging to the first part of individuals solely according to said first direction corresponding to a random elementary direction.

7.- Method according to claim 6 characterised in that it comprises the phase of:
updating (100) on said temporal window the position of each individual belonging to the first part of individuals in a random manner.

8.- Method according to claim 1 characterised in that it comprises the phases of:
assigning (100) to each of said destination areas a minimum distance;
updating (150) the position of each individual belonging to the first part of individuals, moving the latter in the elementary direction corresponding to said first direction, when the distance of its own position with respect to the respective destination area satisfies a predetermined relationship with said minimum distance.

9.- Method according to claim 8 characterised in that it comprises the phase of:
updating (150) the position of each individual belonging to the first part of individuals, moving the latter in the elementary direction corresponding to said first direction, when the distance of its own position with respect to the respective destination area is less than said minimum distance.

10.- Method according to claim 1 characterised in that it comprises the phase of defining (100) said urban area by means of at least one means of transport suited for moving said individuals at a first speed of movement through a predetermined sequence of nodes.

11. Method according to claim 9 characterised in that said condition of mobility comprises a first condition in which the position, the speed and the direction of movement of said individual is respectively equal to the position, speed and direction of said means of transport, a second condition in which the position of said individual remains unchanged, and a third condition in which said individual moves between two nodes with a second speed of movement.
